(19) United States
(12) Patent Application Publication
(10) Pub. No.: US 2014/0341443 A1
(43) Pub. Date: Nov. 20, 2014

(54) JOINT MODELING FOR FACIAL RECOGNITION

(71) Applicant: MICROSOFT CORPORATION, Redmond, WA (US)

(72) Inventors: Xudong Cao, Beijing (CN); Fang Wen, Beijing (CN); Jian Sun, Beijing (CN); Dong Chen, Beijing (CN)

(73) Assignee: MICROSOFT CORPORATION, Redmond, WA (US)

(21) Appl. No.: 13/896,206

(22) Filed: May 16, 2013

(51) Int. Cl. G06K 9/00

(52) U.S. Cl. CPC G06K 9/00221
USPC 382/118

(57) ABSTRACT

This disclosure describes a system for jointly modeling images for use in performing facial recognition. A facial recognition system may jointly model a first image and a second image using a face prior to generate a joint distribution. Conditional joint probabilities are determined based on the joint distribution. A log likelihood ratio of the first image and the second image are calculated based on the conditional joint probabilities and the subject of the first image and the second image are verified as the same person or as different people based on results of the log likelihood ratio.

### BACKGROUND

The field of facial recognition continues to experience rapid growth, both in the areas of facial verification, identifying if two faces belong to the same person, and in facial identification, the process of identifying a person from a set of facial images. While the application of facial recognition as a technique for identification has expanded greatly to encompass all manner of devices, the accuracy of the methods used to perform the verification process leaves much to be desired.

The predominate methods used in the field of facial recognition today often require the individual to be identified to be in similar conditions and positions when the facial images are captured. That is these types of methods often have difficulty in compensating for differences in alignment, pose and/or lighting of the facial images, as they rely on an analysis of the differences in the two images to perform the identification.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Implementations of a system for utilizing facial recognition to verify the identity of a user are disclosed herein. In one example, the system jointly models two images (the image of the user to be verified and a known image of the user) during the analysis to verify the identity of the user. For instance, the system may represent the images as a sum of two independent Gaussian variables. In one implementation, the system may utilize two hypotheses to identify two conditional joint probabilities, the first hypothesis representing the idea that both images are of the same person and the second hypothesis representing the idea that the two images are of different people. The log likelihood ratio of the two joint probabilities may then be computed to verify the identity of the user. In some implementations, support vector machines (SVM) may be utilized to train the system to train the system to learn the parameters of the joint distribution.

### BRIEF DESCRIPTION OF THE DRAWINGS

The Detailed Description is described with reference to the accompanying figures. In the figures, the left-most digit(s) of a reference number identifies the figure in which the reference number first appears. The same numbers are used throughout the drawings to reference like features and components.

FIG. 1 is a pictorial view of an example system for performing facial recognition according to some implementations.

FIG. 2 is a block diagram of an example framework of a computing device according to some implementations.

FIG. 3 is a system flow diagram of an example process for verifying two images are of the same subject according to some implementations.

FIG. 4 is a system flow diagram of an example process utilizing an Expectation-Maximization (EM) approach to train model parameter according to some implementations.

### DETAILED DESCRIPTION

### Overview

The disclosed techniques describe implementations for utilizing facial recognition to perform facial verification and facial identification. In the following discussion, the Bayesian face recognition method is adapted to utilize a joint formation and/or a “face prior” to more accurately perform facial verification. For instance, in one implementation, the Bayesian face recognition may be formulated as a binary Bayesian decision problem of the intrinsic differences comprising an intra-personal hypothesis (H_{I}), that is that two images represent the same subject, and an extra-personal hypothesis (H_{E}), that is that two images represent different subjects. The facial verification problem may then be reduced to classifying the difference of two images {x₁ and x₂} using either the first hypothesis or the second hypothesis as represented by the equation Δ=x₁−x₂. The verification decision may then be made using the Maximum a Posterior (MAP) rule and by testing a log likelihood ratio:

$$r ( {x}_{1} , {x}_{2} ) = log \frac{P ( Δ \vert {H}_{I} )}{P ( Δ \vert {H}_{E} )} \qquad ( 1 )$$

In some implementations, the log likelihood ratio may be considered as a probabilistic measure of similarity between the two images {x₁ and x₂}. In this implementation, the two conditional probabilities P(Δ|H_{I}) and P(Δ|H_{E}) are modeled as Gaussians and an Eigen analysis may be applied to a training set of images to improve the efficiency of the computations required to verify a facial image of a subject. By modeling the log likelihood ratio as Gaussian probabilities and excluding the transform difference and the noise subspaces, typically associated with Bayesian process, more accurate facial recognition is realized.

By jointly modeling two images {x₁, x₂} rather than differences between the images Δ=x₁−x₂ in a Bayesian framework leads to more discriminative classification criterion for facial verification tasks. For example, the parameters of the joint distribution of two facial images may be learned via a data driven approach. In another example, the parameters of the joint distribution of two facial images may be learned based on a face prior to improve accuracy.

In one implementation, the joint distribution of the images {x₁, x₂} may be directly modeled as Gaussians whose parameters are learned via a data driven approach. In this implementation, the conditional probabilities may be modeled as P(x₁, x₂|H_{I})=N(0,_{I}) and P(x₁, x₂|H_{E})=N(0,_{E}), where _{I} and _{E} are covariant matrixes estimated from the intra-personal pairs and extra-personal pairs respectively. During the verification process, the log likelihood ratio between the two probabilities may be used as the similarity metric.

In another implementation, a facial image may be represented based on a “face prior.” As used herein, the face prior is influenced by two factors, the identity of the subject and the intra-personal variations, such as expression, lighting, etc. According to the face prior, a facial image may then be configured as the sum of two independent Gaussian variables, i.e. x=μ+ε where x is the observed facial images with the mean of all faces subtracted, μ represents the identity of the images and ε represents the intra-personal variation between the images. For example, two images may be of the same subject (i.e. they have the same identify μ) but have variations in lighting, poses and expressions of the subject. These variations are represented by the variable ε. The variables μ and ε may be modeled using two Gaussian distributions N(0,S_{μ}) and N(0,S_{ε}), where S_{μ} and S_{ε} are covariance matrices.

Using the face prior as described above, the joint distribution of the two images {x₁, x₂} under intra-personal hypothesis (H_{I}) and extra-personal hypothesis (H_{E}) may be formed using Gaussians with zero means. The covariance of the Gaussians could be computed based on the following equation:

cov(xᵢ,xⱼ)=cov(μᵢ,μⱼ)+cov(εᵢ,εⱼ), i,j ∈ {1,2} (2)

Under the intra-personal hypothesis (H_{I}), the identities μᵢ and μⱼ of the pair of images {x₁, x₂} are the same and the intra-person variations εᵢ and εⱼ of images {x₁, x₂} are independent. Thus, the covariance matrix of the distribution P(x₁, x₂|H_{I}) is:

$${Σ}_{I} = [ \begin{matrix}cov ( x 1 , x 1 \vert {H}_{I} ) cov ( x 1 , x 2 \vert {H}_{I} ) \\ cov ( x 2 , x 1 \vert {H}_{I} ) cov ( x 2 , x 2 \vert {H}_{I} )\end{matrix} ] = [ \begin{matrix}{S}_{μ} + {S}_{ɛ} & {S}_{μ} \\ {S}_{μ} & {S}_{μ} + {S}_{ɛ}\end{matrix} ] \qquad ( 3 )$$

Under the extra-personal hypothesis (H_{E}), both the identities μᵢ and μⱼ of the pair of images {x₁, x₂} and the intra-person variations εᵢ and εⱼ of the images {x₁, x₂} are independent. Thus, the covariance matrix of the distribution P(x₁, x₂|H_{E}) is:

$${Σ}_{E} = [ \begin{matrix}cov ( x 1 , x 1 \vert {H}_{E} ) cov ( x 1 , x 2 \vert {H}_{E} ) \\ cov ( x 2 , x 1 \vert {H}_{E} ) cov ( x 2 , x 2 \vert {H}_{E} )\end{matrix} ] = [ \begin{matrix}{S}_{μ} + {S}_{ɛ} & 0 \\ 0 & {S}_{μ} + {S}_{ɛ}\end{matrix} ] \qquad ( 4 )$$

Based on the covariance matrices _{I} and _{E} above, the log likelihood ratio, r(x₁, x₂), is obtained in a closed form as follows:

$$r ( {x}_{1} , {x}_{2} ) = log \frac{P ( {x}_{1} , {x}_{2} \vert {H}_{I} )}{P ( {x}_{1} , {x}_{2} \vert {H}_{E} )} = {x}_{1}^{T} {Ax}_{1} + {x}_{2}^{T} {Ax}_{2} - 2 {x}_{1}^{T} {Gx}_{2} where \\ A = {( {S}_{μ} + {S}_{ɛ} )}^{- 1} - ( F + G ) and ( \begin{matrix}F + G & G \\ G & F + G\end{matrix} ) = {( \begin{matrix}{S}_{μ} + {S}_{ɛ} & {S}_{μ} \\ {S}_{μ} & {S}_{μ} + {S}_{ɛ}\end{matrix} )}^{- 1} \qquad ( 5 )$$

In the above listed equations it should be noted that, both matrix A and G are negative semi-definite matrixes, the negative log likelihood ratio degrades to a Mahalanobis distance if A=G and the log likelihood ratio metric is invariant to any full rank linear transform.

In one particular implementation, an expectation-maximization (EM) approach is utilized to learn the parametric models of the two variables, S_{μ} and S_{ε}. Once the models are learned, the joint distributions of two images {x₁, x₂} may be derived from a closed-form expression of the log likelihood ratio, which results in efficient computation during the verification process. The training data, typically, should have a large number of different subjects with enough subjects having multiple images.

In one particular implementation, the matrixes, S_{μ} and S_{ε}, are jointly estimated or learned from the data sets. For example, a pool of subjects each with m images may be used to train the parameters. The matrixes S_{μ} and S_{ε} are initially set as random positive definite matrixes, before the expectation (E) step is preformed. Once the matrices, S_{μ} and S_{ε}, are initialized, a relationship between a latent variable h, where h=[μ; ε₁ . . . ; εₘ], and x=[x₁; . . . ; xₘ] is determined. The relationship may be expressed as:

$$x = Ph , where P = [ \begin{matrix}I & I & 0 & … & 0 \\ I & 0 & I & … & 0 \\ ⋮ & ⋮ & … & ⋱ & ⋮ \\ I & 0 & 0 & … & I\end{matrix} ] \qquad ( 6 )$$

The distribution of the variable h is h˜N(0,ₕ), where ₕ=diagonal (S_{μ}, S_{ε}, . . . , S_{ε}). Therefore the distribution of x is as follows:

$$x ∼ N ( 0 {,}_{x} ) , {where}_{ x} = [ \begin{matrix}{S}_{μ} + {S}_{ɛ} & {S}_{μ} & … & {S}_{μ} \\ {S}_{μ} & {S}_{μ} + {S}_{ɛ} & … & {S}_{μ} \\ ⋮ & … & ⋱ & ⋮ \\ {S}_{μ} & {S}_{μ} & … & {S}_{μ} + {S}_{ɛ}\end{matrix} ] \qquad ( 7 )$$

The expectation of the latent variable h is E(h|x)=ₕP^{T-1}ₓx.

In the maximization (M) step, the values of parameters which can be represented by ⊖={S_{μ}, S_{ε}} are updated, where μ and ε are latent variable estimated in the E step, as discussed above with respect to h. The maximization process includes calculating updates for S_{μ} by computing the cov(μ) and S_{ε} by computing the cov(ε). As the covariance of S_{μ} and S_{ε} is determined the model parameters ⊖ are updated (trained), such that more accurate facial verification is achieved.

### Illustrative Environment

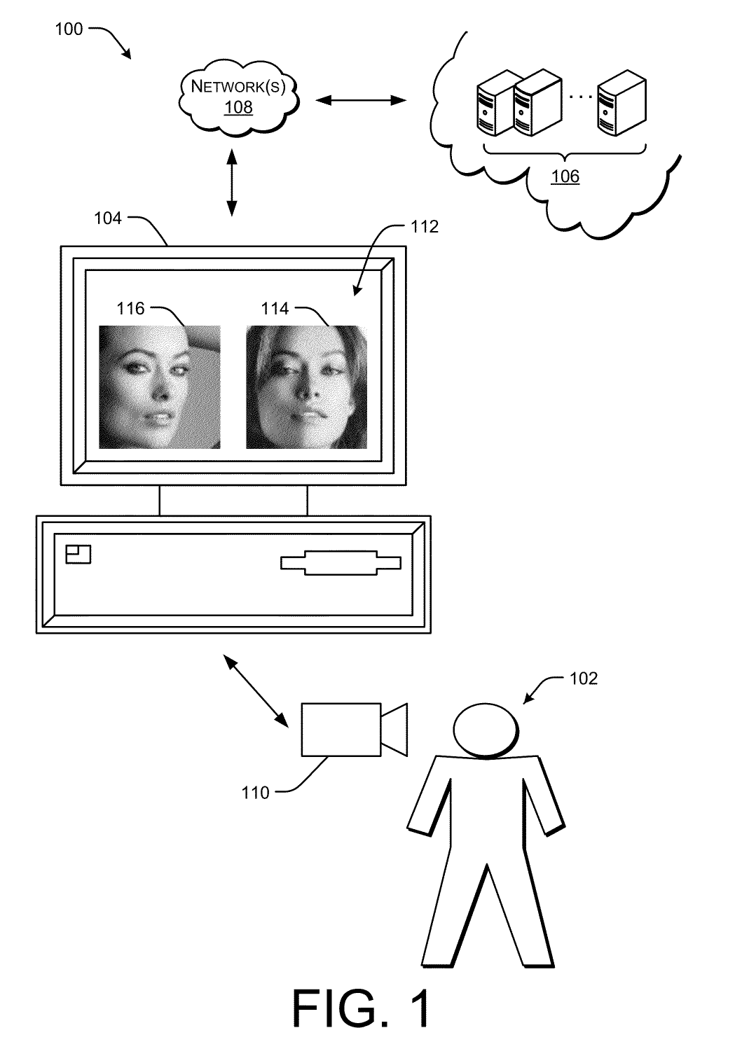

FIG. 1 is a pictorial view of an example system 100 for performing facial recognition according to some implementations. In the illustrated example, a user 102 is attempting to access a computing device 104 and/or a server system 106 in communication with the computing device 104 via one or more networks 108.

The computing device 104 is a part of a computing system configured to verify the identity of the user 102 and grant access to the system based on facial recognition. The computing system, generally, includes one or more cameras 110, one or more processors, one or more input/output devices (such as a keyboard, mouse and/or touch screens) and one or more displays 112. The computing device 104 may be a tablet computer, cell phone, smart phone, desktop computer, notebook computer, among other types of computing devices.

The one or more cameras 110 may be one or more internal cameras integrated into the computing device or the cameras 110 maybe one or more external cameras connected to the computing device, as illustrated. Generally, the cameras 110 are configured to capture a facial image of the user 102, which may be verified by the facial recognition system 100 before the user 102 is granted access to the system 100.

The displays 112 may be configured to show the user 102 a verification image 114 (i.e. the image of the authorized user) and the captured image 116 (i.e. the image of the user 102 captured by the cameras 110). For example, by displaying the images 114 and 116 to the user 102 on display 112, the user 102 may decide if the image 116 should be submitted for verification or if the user 102 needs to take a new photo before submitting. For instance, as illustrated, the captured image 116 shows more of the side of the face of the user 102 than the verification image 114. In some cases, the user 102 may wish to retake the captured image 116 to more closely replicate the angle of the verification image 114 before submitting. However, in some implementations, the system may operate without displaying images 116 and 114 to the user 102 for security or other reasons.

The computing device 104 may also include one or more communication interfaces for communication with one or more servers 106 via one or more networks 108. For example, the computing device 104 may be communicatively coupled to the networks 108 via wired technologies (e.g., wires, USB, fiber optic cable, etc.), wireless technologies (e.g., RF, cellular, satellite, Bluetooth, etc.), or other connection technologies.

The networks 108 are representative of any type of communication network, including data and/or voice network, and may be implemented using wired infrastructure (e.g., cable, CAT5, fiber optic cable, etc.), a wireless infrastructure (e.g., RF, cellular, microwave, satellite, Bluetooth, etc.), and/or other connection technologies. The networks 108 carry data, such as image data, between the servers 106 and the computing device 104.

The servers 106 generally refer to a network accessible platform implemented as a computing infrastructure of processors, storage, software, data access, and so forth that is maintained and accessible via the networks 108 such as the Internet. The servers 106 may be arranged in any number of ways, such as server farms, stacks, and the like that are commonly used in data centers. In some implementations, the servers 106 perform the verification process on behalf of the computing device 104. For example, the servers 106 may include SVMs for training models to be used for facial recognition. The servers 106 may also include a facial verification module to verify the identity of the user 102 based on the trained models.

In the illustrated example, the user 102 is attempting to access a computing device 104 and/or a server system 106. In this example, the user 102 takes a picture of their face using cameras 110 to generate the captured image 116. The computing device 104 jointly models the images 114 and 116 as two Gaussian distributions N(0, S_{μ}) and N(0, S_{ε}) with zero means using the face prior x=μ+ε, where μ is the identity of the subject of the images 114 and 116 and ε is the variation between the images 114 and 116. For example, in the illustrated example, the images 114 and 116 have the same identity μ as both images are of the same subject (i.e. the user 102). However, the images 114 and 116 have multiple variations ε such as the expression and pose of the user 102 in each of the images 114 and 116.

The jointly modeled images 114 and 116 may be reduced into two conditional joint probabilities, one under the intra-personal hypothesis H_{I} and one under the extra-personal hypothesis H_{E}, as discussed above. The two conditional joint probabilities P(x₁,x₂|H_{I}) and P(x₁,x₂|H_{E}) may be expressed as follows:

$$\begin{matrix}{Σ}_{I} = [ \begin{matrix}{S}_{μ} + {S}_{ɛ} & {S}_{μ} \\ {S}_{μ} & {S}_{μ} + {S}_{ɛ}\end{matrix} ] and & ( 3 ) \\ {Σ}_{E} = [ \begin{matrix}{S}_{μ} + {S}_{ɛ} & 0 \\ 0 & {S}_{μ} + {S}_{ɛ}\end{matrix} ] & ( 4 )\end{matrix}$$

Based on the conditional joint probabilities _{I} and _{E} above, the verification may be reduced to a log likelihood ratio, r(x₁,x₂), obtained in a closed from as follows:

$$r ( {x}_{1} , {x}_{2} ) = log \frac{P ( {x}_{1} , {x}_{2} \vert {H}_{I} )}{P ( {x}_{1} , {x}_{2} \vert {H}_{E} )} = {x}_{1}^{T} {Ax}_{1} + {x}_{2}^{T} {Ax}_{2} - 2 {x}_{1}^{T} {Gx}_{2} where \\ A = {( {S}_{μ} + {S}_{ɛ} )}^{- 1} - ( F + G ) and ( \begin{matrix}F + G & G \\ G & F + G\end{matrix} ) = {( \begin{matrix}{S}_{μ} + {S}_{ɛ} & {S}_{μ} \\ {S}_{μ} & {S}_{μ} + {S}_{ɛ}\end{matrix} )}^{- 1} \qquad ( 5 )$$

By solving the log likelihood ratio, r(x₁,x₂), the images 114 and 116 may either be verified as belonging to the same subject and the user 102 is granted access or as belonging to separate subjects and the user 102 is denied access.

In an alternative implementation, the computing device 104 may provide the captured image 116 to the servers 106 via the networks 108 and the servers 106 may perform the joint modeling and facial recognition process discussed above. For example, the user 102 may be attempting to access one or more cloud services hosted by the servers 106 for which the cloud services use facial recognition to verify the identity of the user 102 when the user 102 logs into the cloud service.

### Illustrative Framework

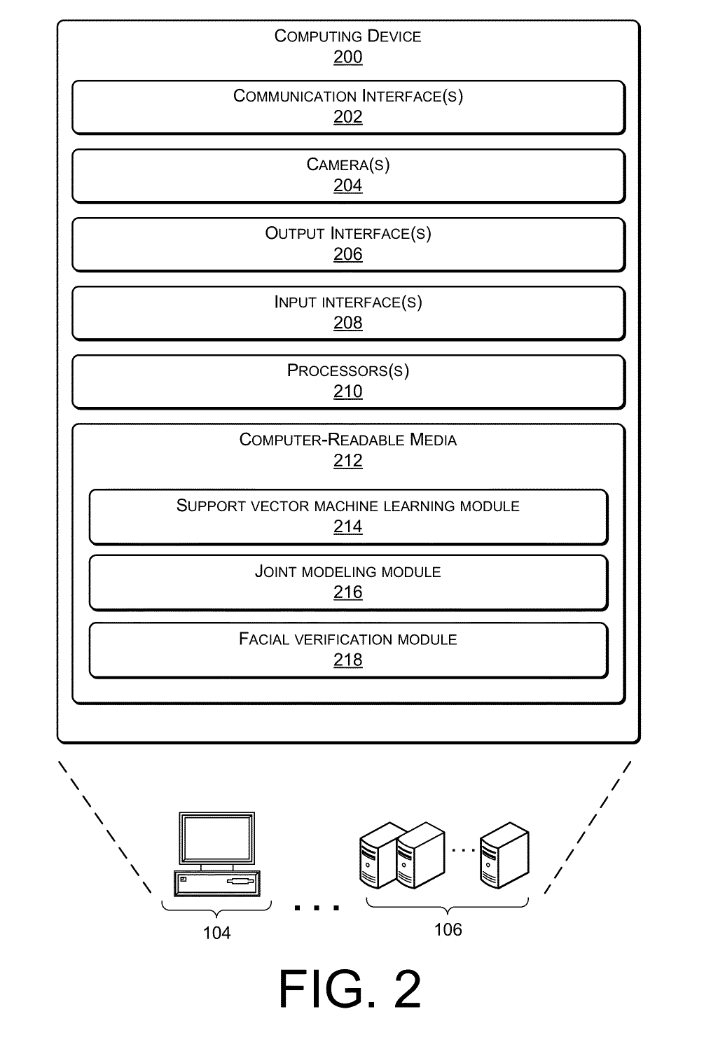

FIG. 2 is a block diagram of an example framework of a computing device 200 according to some implementations. Generally, the computing device 200 may be implemented as a standalone device, such as the computing device 104 of FIG. 1, or as part of a larger electronic system, such as one or more of the servers 106 of FIG. 1. In the illustrated implementation, the computing device 200 includes, or accesses, components such as a one or more communication interfaces 202, one or more cameras 204, one or more output interfaces 206, one or more input interfaces 208, in addition to various other components.

The computing device 200 also includes, or accesses, at least one control logic circuit, central processing unit, one or more processors 210, in addition to one or more computer-readable media 212 to perform the function of the computing device 200. Additionally, each of the processors 210 may itself comprise one or more processors or processing cores.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

As used herein, “computer-readable media” includes computer storage media and communication media. Computer storage media includes volatile and non-volatile, removable and non-removable media implemented in any method or technology for storage of information, such as computer-readable instructions, data structures, program modules, or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVD) or other optical storage, magnetic cassettes, magnetic tape, magnetic disk storage or other magnetic storage devices, or any other tangible medium that can be used to store information for access by a computing device.

In contrast, communication media may embody computer-readable instructions, data structures, program modules, or other data in a modulated data signal, such as a carrier wave. As defined herein, computer storage media does not include communication media.

Several modules such as instruction, data stores, and so forth may be stored within the computer-readable media 212 and configured to execute on the processors 210. For example, a support vector machine learning module 214 provides at least some basic machine learning to learn/train the parametric models of the variables, S_{μ} and S_{ε}, as discussed above. A joint modeling module 216 provides for modeling two images (such as verification image 114 and captured image 116) jointly, either using a face prior or directly as Gaussian distributions in a Bayesian framework. A facial verification module 218 is configured to utilize the jointly modeled images to perform a log likelihood ratio and verify if the two images are of the same subject.

The amount of capabilities implemented on the computing device 200 is an implementation detail, but the architecture described herein supports having some capabilities at the computing device 200 together with more remote servers implemented with more expansive facial recognition systems. Various, other modules (not shown) may also be stored on computer-readable storage media 212, such as a configuration module or to assist in an operation of the facial recognition system, as well as reconfigure the computing device 200 at any time in the future.

The communication interfaces 202 facilitate communication between the remote severs, such as to access more extensive facial recognition systems, and the computing device 200 via one or more networks, such as networks 108. The communication interfaces 202 may support both wired and wireless connection to various networks, such as cellular networks, radio, WiFi networks, short-range or near-field networks (e.g., Bluetooth®), infrared signals, local area networks, wide area networks, the Internet, and so forth.

The cameras 204 may be one or more internal cameras integrated into the computing device 200 or one or more external cameras connected to the computing device, such as through one or more of the communication interfaces 202. Generally, the cameras 204 are configured to capture facial images of the user, which may then be verified by the processors 210 executing the facial verification module 218 before the user is granted access to the computing device 200 or another device.

The output interfaces 206 are configured to provide information to the user. For example, the display 112 of FIG. 1 may be configured to display to the user a verification image (i.e. the image of the authorized user) and the captured image (i.e. the image of the user captured by the cameras 204) during the verification process.

The input interfaces 208 are configured to receive information from the user. For example, a haptic input component, such as a keyboard, keypad, touch screen, joystick, or control buttons may be utilized for the user to input information. For instance, the user may begin the facial variation process by selecting the “enter key” on a keyboard.

In another instance, the user may use a natural user interface (NUI) that enables the user to interact with a device in a “natural” manner, free from artificial constraints imposed by input devices such as mice, keyboards, remote controls, and the like. For example, the NUI may includes speech recognition, touch and stylus recognition, motion or gesture recognition both on screen and adjacent to the screen, air gestures, head and eye tracking, voice and speech, vision, touch, gestures, and machine intelligence.

Generally when the user attempts to access the computing device 200, the user utilizes cameras 204 to take a photograph of their face to generate an image to be verified (such as the captured image 116 of FIG. 1). When the computing device 200 receives the image to be verified, the processors 210 execute the joint modeling module 216. The joint modeling module 216 causes the processors to jointly model the image to be verified with a verification image. For instance, the users may select a verification image of themselves from a list of authorized user using the input and output interfaces 206 and 208.

In one implementation, the processors 210 model the two images directly as Gaussian distributions. In this implementation, the conditional probabilities are modeled as P(x₁,x₂|H_{I})=N(0,_{I}) and P(x₁,x₂|H_{E})=N(0,_{E}), where x₁ and x₂ are the two images and _{I} and _{E} are covariant matrixes estimated from the images under the two hypotheses described above, i.e., the intra-personal hypothesis (H_{I}) in which the two images are of the same subject and the extra-personal hypothesis (H_{E}) where the two images are different subjects.

In another implementation, the processors 210 model the two images as two Gaussian distributions N(0, Sμ) and N(0, Sε) with zero means using a face prior (x=μ+ε), where μ is the identity of the subject of the images and ε is the variation between the images. In this implementation, the two conditional joint probabilities, the first under the intra-personal hypothesis (H_{I}) and the second under the extra-personal hypothesis (H_{E}) may be expressed as follows:

$$\begin{matrix}{Σ}_{I} = [ \begin{matrix}{S}_{μ} + {S}_{ɛ} & {S}_{μ} \\ {S}_{μ} & {S}_{μ} + {S}_{ɛ}\end{matrix} ] and & ( 3 ) \\ {Σ}_{E} = [ \begin{matrix}{S}_{μ} + {S}_{ɛ} & 0 \\ 0 & {S}_{μ} + {S}_{ɛ}\end{matrix} ] & ( 4 )\end{matrix}$$

Once the two images are modeled as joint distributions and the conditional joint probabilities are determined, the processors 210 execute the facial verification module 218 to determine if the image to be verified is the subject of the verification image. During execution of the facial verification module 218, the processors 210 obtain the log likelihood ratio using the conditional joint probabilities _{I} and _{E}. For example, when using the face prior the verification may be reduced to the log likelihood ratio as follows:

$$r ( {x}_{1} , {x}_{2} ) = log \frac{P ( {x}_{1} , {x}_{2} \vert {H}_{I} )}{P ( {x}_{1} , {x}_{2} \vert {H}_{E} )} = {x}_{1}^{T} {Ax}_{1} + {x}_{2}^{T} {Ax}_{2} - 2 {x}_{1}^{T} {Gx}_{2} where \\ A = {( {S}_{μ} + {S}_{ɛ} )}^{- 1} - ( F + G ) and ( \begin{matrix}F + G & G \\ G & F + G\end{matrix} ) = {( \begin{matrix}{S}_{μ} + {S}_{ɛ} & {S}_{μ} \\ {S}_{μ} & {S}_{μ} + {S}_{ɛ}\end{matrix} )}^{- 1} \qquad ( 5 )$$

By solving the log likelihood ratio r(x₁,x₂), the images may be verified as belonging to the same subject and the user is granted access or as belonging to different subjects and the user is denied access.

The computing device 200 may also train the parameters using the expectation-maximization (EM) method. For example, the processors 210 may execute the EM learning module 214, which causes the processors 210 to estimate or learn the matrixes, S_{μ} and S_{ε}, from data sets. In one implementation, the processor utilizes the expectation-maximization (EM) method to update the matrixes. In the expectation (E) step a relationship between latent variables, for example purposes we use the latent variable h, where h=[μ; ε₁ . . . ; εₘ] and a set of m images are represented as x=[x₁; . . . ; xₘ] and each image is modeled as xᵢ=μ+ε. The relationship may be expressed as:

$$x = Ph , where P = [ \begin{matrix}I & I & 0 & … & 0 \\ I & 0 & I & … & 0 \\ ⋮ & ⋮ & … & ⋱ & ⋮ \\ I & 0 & 0 & … & I\end{matrix} ] \qquad ( 6 )$$

The distribution of the variable h may then be written as h˜N(0,ₕ), where ₕ=diagonal (S_{μ}, S_{ε}, . . . , S_{ε}). Therefore the distribution of x is as follows:

$$x ∼ N ( 0 {,}_{x} ) , {where}_{ x} = [ \begin{matrix}{S}_{μ} + {S}_{ɛ} & {S}_{μ} & … & {S}_{μ} \\ {S}_{μ} & {S}_{μ} + {S}_{ɛ} & … & {S}_{μ} \\ ⋮ & … & ⋱ & ⋮ \\ {S}_{μ} & {S}_{μ} & … & {S}_{μ} + {S}_{ɛ}\end{matrix} ] \qquad ( 7 )$$

Thus the expectation of the latent variable h becomes

$$E ( h \vert x ) = {}_{h}^{}{P}{}_{x}^{T - 1} x .$$

In the maximization (M) step, updates for S_{μ} are computed by calculating the cov(μ) and updates for S_{ε} are computed by calculating the cov(ε). Thus, the parameters may be trained to achieve more accurate results when an image is submitted for verification.

### Illustrative Processes

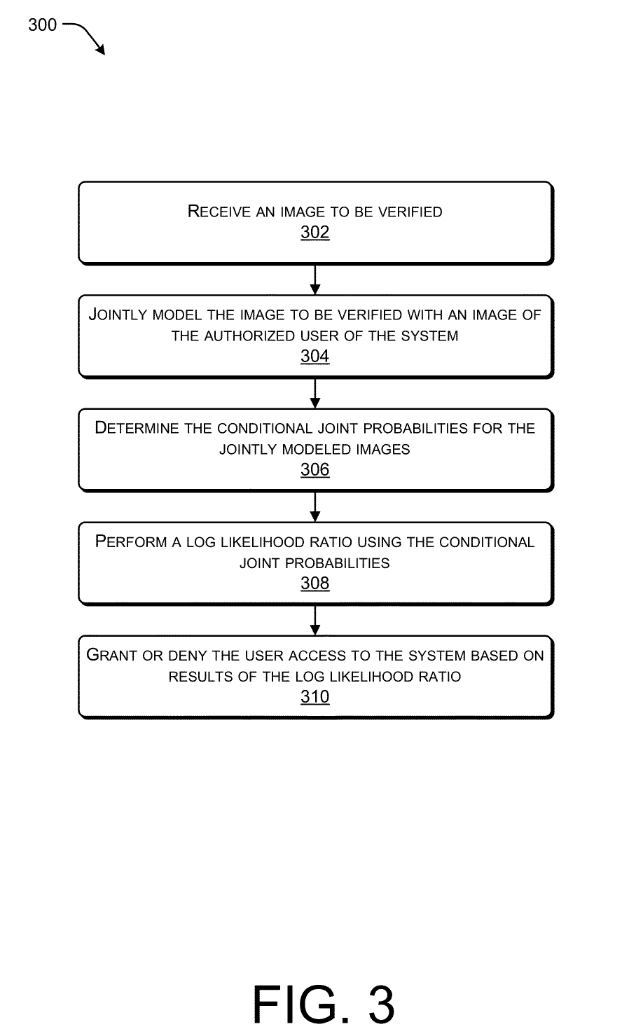

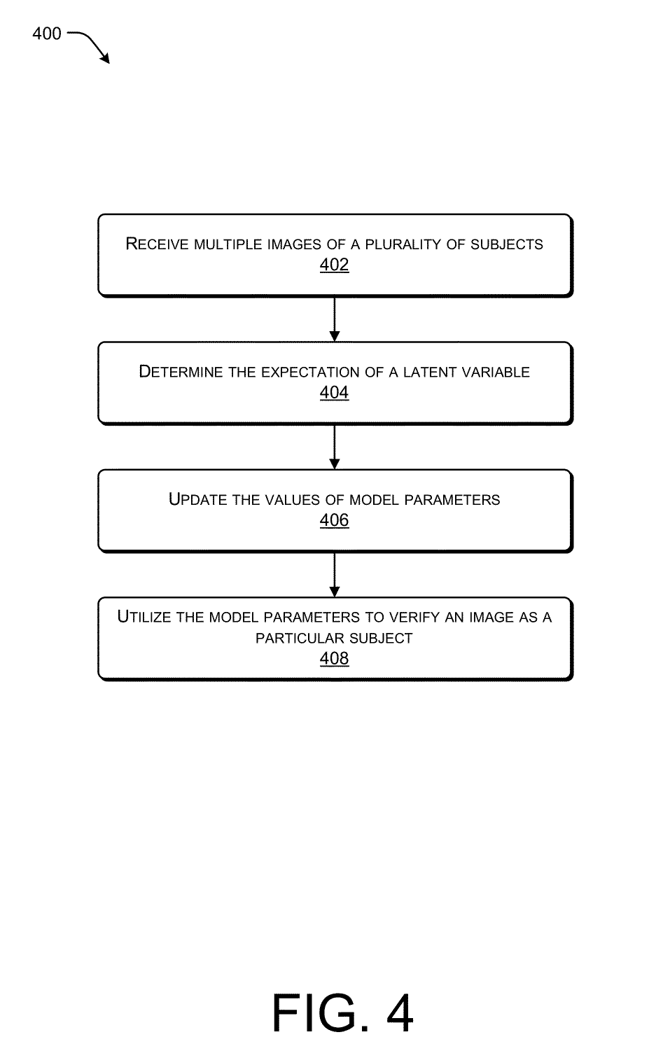

FIGS. 3 and 4 are flow diagrams illustrating example processes for jointly modeling two images for use in facial recognition. The processes are illustrated as a collection of blocks in a logical flow diagram, which represent a sequence of operations, some or all of which can be implemented in hardware, software or a combination thereof. In the context of software, the blocks represent computer-executable instructions stored on one or more computer-readable media that, which when executed by one or more processors, perform the recited operations. Generally, computer-executable instructions include routines, programs, objects, components, data structures and the like that perform particular functions or implement particular abstract data types.

The order in which the operations are described should not be construed as a limitation. Any number of the described blocks can be combined in any order and/or in parallel to implement the process, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 3 is a system flow diagram of an example process 300 for verifying whether two images are of the same subject. At 302, a system receives an image to be verified. For example, a user may be attempting to access the system by verifying their identity using facial recognition. The image may be captured by a camera directly connected to the system or from a remote device via one or more networks.

At 304, the system jointly models the image to be verified with an image of the authorized user of the system. In various implementations, the system may model the images directly as Gaussian distributions or utilize the face prior, x=μ+ε. If the face prior is utilized, μ represents the identity of the subject of the images and ε represents the intra-personal variations. For instance, the images may have the same identity μ if both images are of the same subject, however, the images may still have multiple variations ε, for example, the lighting, expression or pose of the subject may be different in each image.

At 304, the system determines the conditional joint probabilities for the jointly modeled images. For example, if the images are modeled directly, the conditional probabilities are P(x₁,x₂|H_{I})=N(0,_{I}) and P(x₁,x₂|H_{E})=N(0,_{E}), where x₁ and x₂ are the images and _{I} and _{E} are covariant matrixes estimated from the images under two hypotheses, the intra-personal hypothesis (H_{I}) in which the images are of the same subject and the extra-personal hypothesis (H_{E}) where the two images are different subjects. If the images are modeled using the face prior then the conditional joint probabilities under H_{I} and H_{E} are Gaussian distributions whose covariance matrices are expressed as follows respectively:

$$\begin{matrix}{Σ}_{I} = [ \begin{matrix}{S}_{μ} + {S}_{ɛ} & {S}_{μ} \\ {S}_{μ} & {S}_{μ} + {S}_{ɛ}\end{matrix} ] and & ( 3 ) \\ {Σ}_{E} = [ \begin{matrix}{S}_{μ} + {S}_{ɛ} & 0 \\ 0 & {S}_{μ} + {S}_{ɛ}\end{matrix} ] & ( 4 )\end{matrix}$$

At 308, the system performs a log likelihood ratio using conditional joint probabilities. For example, if the face prior is utilized, the log likelihood ratio may be expressed as follows:

$$r ( {x}_{1} , {x}_{2} ) = log \frac{P ( {x}_{1} , {x}_{2} \vert {H}_{I} )}{P ( {x}_{1} , {x}_{2} \vert {H}_{E} )} = {x}_{1}^{T} {Ax}_{1} + {x}_{2}^{T} {Ax}_{2} - 2 {x}_{1}^{T} {Gx}_{2} where \\ A = {( {S}_{μ} + {S}_{ɛ} )}^{- 1} - ( F + G ) and ( \begin{matrix}F + G & G \\ G & F + G\end{matrix} ) = {( \begin{matrix}{S}_{μ} + {S}_{ɛ} & {S}_{μ} \\ {S}_{μ} & {S}_{μ} + {S}_{ɛ}\end{matrix} )}^{- 1} \qquad ( 5 )$$

At 310, the system either grants or denies the user access based on the results of the log likelihood ratio. For example, the ratio may be compared to a threshold to determine the facial verification. For instance, if the ratio is above a threshold the system may grant the user access as the two images are similar enough that it can be verified that they are of the same subject. In this manner, different pre-defined thresholds may be utilized to, for example, increase security settings by increasing the threshold.

FIG. 4 is a system flow diagram of an example process 400 utilizing the Expectation-Maximization (EM) method to train model parameters. For example, the EM approach may be utilized to learn the parametric models of the variables, S_{μ} and S_{ε} according to a joint model utilizing the face prior, x=μ+ε. At 402, a system receives multiple image of a plurality of subjects. The images may be used as training data to learn the parametric models of the variables, S_{μ} and S_{ε}. The training data, typically, has a large number of different subjects and enough of the subjects with multiple images. For instance, a pool of subjects each with m images may be received.

At 404, the system determines the expectation of a latent variable h, where h=[μ; ε₁ . . . ; εₘ], and x=[x₁; . . . ; xₘ] with xᵢ=μ+ε. Initially, the matrices S_{μ} and S_{ε} are set as random positive definite matrices. Next, the relationship between a latent variable h, and the x=[x₁; . . . ; xₘ] is determined The relationship may be expressed as:

$$x = Ph , where P = [ \begin{matrix}I & I & 0 & … & 0 \\ I & 0 & I & … & 0 \\ ⋮ & ⋮ & … & ⋱ & ⋮ \\ I & 0 & 0 & … & I\end{matrix} ] \qquad ( 6 )$$

The distribution of the variable h is, thus, expressed as h˜N(0,ₕ), where ₕ=diagonal (S_{μ}, S_{ε}, . . . , S_{ε}). Therefore the distribution of x is as follows:

$$x ∼ N ( 0 {,}_{x} ) , {where}_{ x} = [ \begin{matrix}{S}_{μ} + {S}_{ɛ} & {S}_{μ} & … & {S}_{μ} \\ {S}_{μ} & {S}_{μ} + {S}_{ɛ} & … & {S}_{μ} \\ ⋮ & … & ⋱ & ⋮ \\ {S}_{μ} & {S}_{μ} & … & {S}_{μ} + {S}_{ɛ}\end{matrix} ] \qquad ( 7 )$$

From the distribution of x, the expectation of the latent variable h may be determined as

$$E ( h \vert x ) = {}_{h}^{}{P}{}_{x}^{T - 1} x .$$

Once the expectation is determined the process 400 proceeds to 406 and the M step.

At 406, the system updates the values of the model parameters represented by ⊖, where ⊖={S_{μ}, S_{ε}} and μ and ε are latent variable estimated in the E step. The system calculates the updates for S_{μ} by computing the cov(μ) and S_{ε} by computing the cov(ε).

At 408, the system utilized the updated model parameters to verify an image as a particular subject as discussed above with respect to FIG. 3. By utilizing the EM approach to model learning the process of verifying an image can be performed more quickly and accurately.

### Conclusion

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

1. A computing device comprising:
one or more input interfaces for receiving a request from a user to access a system, the request including a facial image in which a subject of the facial image is the user requesting access to the system;
an image module to access a verification image associated with the request from the user to access the system;
a joint modeling module to jointly model the verification image with the facial image as conditional joint probabilities, the joint model including at least one first factor representing an identity of the subjects and at least one second factor representing a variation between the verification image and the facial image; and
a verification module to calculate a log likelihood ratio of the verification image and the facial image based on the conditional joint probabilities and to grant or deny access to the system based on results of the log likelihood ratio.

2. The computing device of claim 1, wherein the joint module includes a third factor representing a second variation between the verification image and the facial image.

3. The computing device of claim 1, wherein the variation between the verification image and the facial image is at least one of lighting, pose or expression.

4. The computing device of claim 1, wherein the conditional joint probabilities are based on an extra-personal hypothesis that the subject of the verification image and the subject of the facial image are different.

5. The computing device of claim 1, wherein the conditional joint probabilities are based on an intra-personal hypothesis that the subject of the verification image and the subject of the facial image are identical.

6. The system of claim 1, wherein parameters of the conditional joint probabilities are trained using model learning techniques.

7. The system of claim 1, wherein parameters of the conditional joint probabilities are trained using a support vector machine.

8. The system of claim 1, wherein parameters of the conditional joint probabilities are trained using an expectation-maximization approach.

9. A computer-readable storage media storing instructions that, when executed by one or more processors, cause the one or more processors to:
receiving a plurality of images, at least some of the plurality of images having the same subject;
jointly model the plurality of images using a prior;
determine an expectation of at least one latent variable of the prior; and
update model parameters based on the expectation of the at least one latent variable.

10. The computer-readable storage media of claim 9, wherein the model parameters are updated by calculating a covariance of the at least one latent variable.

11. The computer-readable storage media of claim 9, further comprising:
jointly modeling a first image containing a first subject and a second image containing a second subject as a joint distribution;
calculating a log likelihood ratio of the first image and the second image based on the updated model parameters; and
determining, based on the log likelihood ratio, whether or not the first subject and the second subject are the same subject.

12. A method comprising:
jointly modeling a first image containing a first subject and a second image containing a second subject as a joint distribution;
calculating a log likelihood ratio of the first image and the second image; and
determining, based on the log likelihood ratio, whether or not the first subject and the second subject are the same subject.

13. The method of claim 12, further comprising:
determining conditional joint probabilities for the first image and second image based in part on a first hypothesis that the subject of the images is the same and a second hypothesis that the subject of the images is different; and
wherein the log likelihood ratio is calculate based on the conditional joint probabilities.

14. The method of claim 12, wherein the first image and the second image are jointly modeled by covariance matrixes.

15. The method of claim 15, wherein at least one parameter of the covariance matrixes is trained by:
determining an expectation of a latent variable of the joint distribution; and
update the least one parameter based on the expectation of the latent variable.

16. The method of claim 12, wherein the joint distribution of the first image and second image are directly modeled as Gaussian distribution.

17. The method of claim 12, wherein the joint distribution of the first image and second image are modeled using a prior.

13. The method of claim 17, wherein prior includes at least a first variable representing an identity of the subject of the first image and the second image and a second variable representing at least one variation between the first image and the second image.

19. The method of claim 18, wherein the prior includes a first variable representing an identity of the subject of the first image and an identity of the subject of the second image.

20. The method of claim 18, wherein the prior includes a second variable representing variations between the first image and the second image.
